(19) United States
(12) Patent Application Publication
(10) Pub. No.: US 2017/0262873 A1
(43) Pub. Date: Sep. 14, 2017

(54) APPARATUS AND METHOD FOR INVENTORY MANAGEMENT WITH SOCIAL MEDIA

(71) Applicant: Wal-Mart Stores, Inc., Bentonville, AR (US)

(72) Inventors: Michael D. Atchley, Springdale, AR (US); Donald R. High, Noel, MO (US)

(21) Appl. No.: 15/457,277

(22) Filed: Mar. 13, 2017

Related U.S. Application Data
(60) Provisional application No. 62/306,899, filed on Mar. 11, 2016.

(51) Int. Cl. G06Q 30/02; G06Q 50/00; G06Q 10/08

(52) U.S. Cl. CPC G06Q 30/0202; G06Q 30/0205; G06Q 10/087; G06Q 50/01

(57) ABSTRACT

Systems, apparatuses, and methods are provided herein for analyzing social media messages for inventory management. A system for analyzing social media messages comprises a communication device, an item identifier database, an inventory database, and a control circuit. The control circuit is configured to aggregate a plurality of social media messages, identify a plurality of messages of interest associated with customers seeking items to purchase, for each message of interest of the plurality of messages of interest: identify an item of interest based on comparing a text of the message of interest with identifying texts in the item identifier database, and identify a customer location associated with the message of interest; determine an item in demand for a geographic location, determine a stock information of the item in demand in the geographic location, and automatically generate an order for the item in demand to be stocked at the geographic location.

### RELATED APPLICATION

This application claims the benefit of the following U.S. Provisional Application No. 62/306,899 filed Mar. 11, 2016, which is incorporated herein by reference in its entirety.

### TECHNICAL FIELD

This invention relates generally to inventory management.

### BACKGROUND

Brick and mortar retail stores have limited shelf space and cannot carry every item for sale. Therefore, customers sometimes cannot find the items they wish to purchase in a store near them.

### BRIEF DESCRIPTION OF THE DRAWINGS

Disclosed herein are embodiments of apparatuses and methods for inventory management with social media. This description includes drawings, wherein:

FIG. 1 is a block diagram of a system in accordance with several embodiments.

FIG. 2 is a flow diagram of a method in accordance with several embodiments.

FIG. 3 is a process diagram in accordance with several embodiments.

FIG. 4 is a system diagram in accordance with several embodiments.

FIG. 5 is a process diagram in accordance with several embodiments.

FIG. 6 is a system diagram in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for inventory management with social media. A system for analyzing social media messages for inventory management comprises: a communication device configured to communicate with one or more social media services, an item identifier database configured to store a plurality of item identifiers each associated with an item for sale and one or more identifying texts associated with each item identifier, an inventory database configured to store inventory information for a plurality of store locations, and a control circuit coupled to the communication device, the item identifier database, and the inventory database, wherein the control circuit is configured to: aggregate a plurality of social media messages from the one or more social media services via the communication device, identify, within the plurality of social media messages, a plurality of messages of interest associated with customers seeking items to purchase, for each message of interest of the plurality of messages of interest: identify an item of interest based on comparing a text of the message of interest with identifying texts in the item identifier database, and identify a customer location associated with the message of interest, determine an item in demand for a geographic location based on items of interests and customer locations identified in the plurality of messages of interest, determine a stock information of the item in demand in the geographic location based on the inventory database; and in the event that the item in demand is not stocked at the geographic location, automatically generate an order for the item in demand to be stocked at the geographic location.

In some embodiments, a central computer system may connect with one or more social media services (e.g. Facebook, Twitter, Pinterest, etc.). In some embodiments, the system may create a request page for consumers to submit item requests. The system may track store numbers in social media messages and correlate items identified in the messages with that store number. The system may compare requested items with items currently on order, in stock, or unavailable at one or more stores. In some embodiments, a consumer may log into a social media service and follow/like a retail entity's request page. A consumer may then using a hashtag (“#”) or other markers to identify the store they are referring to (ex. “#5261”). The system may generally track the inventory information of one or more stores. A consumer may input the product they wish that store would carry. Different store locations of a retail entity may offer different items for sale based on the demographic of the area of the store location. With a system that determines what to carry at each store based on customer social media messages, customers may not have to go to multiple stores to make purchases. Once a specified amount of requests has been made for a specific store location, the request may be filled by the retail company. After a specific number of requests are made, the system may add that product to an order for a store location and may notify a store manager to place the new product on the shelves of the sales floor to offer it for sale. With the notification, the store manager may designate associates to put the ordered item(s) on a display module as soon as it arrives. Once the product has arrived at a store and placed on a display module, the system may alert the consumer(s) who requested the item that their requested item is in-stock at the designated store. The message may be sent out using information that was used to record and validate item request messages from social media services.

In some embodiments, systems, and methods described herein receive and fulfill social media messages that request products to be sold in a store. In some embodiments, the system may track hashtags associated with store numbers to detect item requests for different store locations. In some embodiments, the system may use the social media service to alert customers when the item they requested has been stocked at a nearby store.

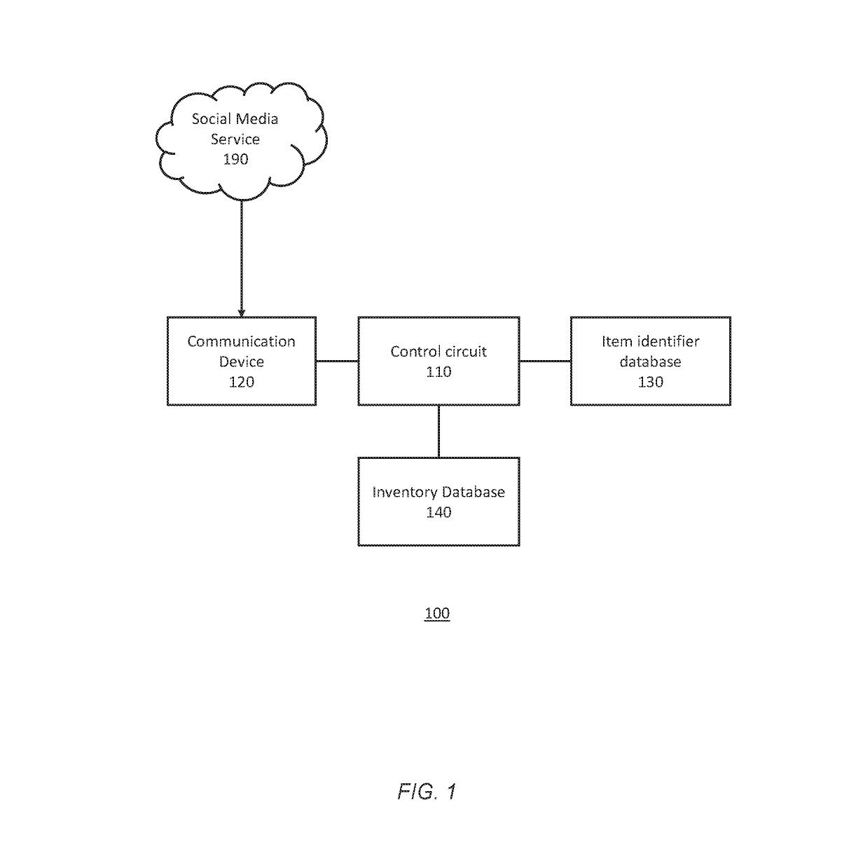

Referring now to FIG. 1, a system for analyzing social media messages for inventory management is shown. The system 100 includes a control circuit 110 coupled to a communication device 120 configured to communicate with one or more social media services 190, an item identifier database 130, and an inventory database 140.

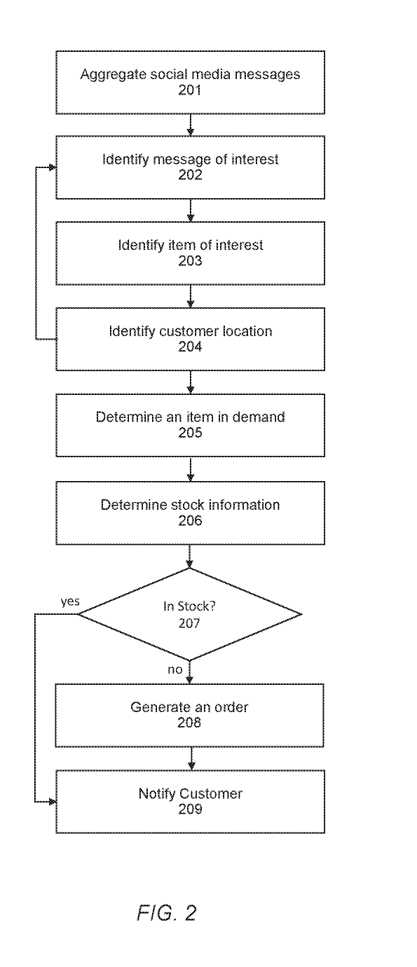

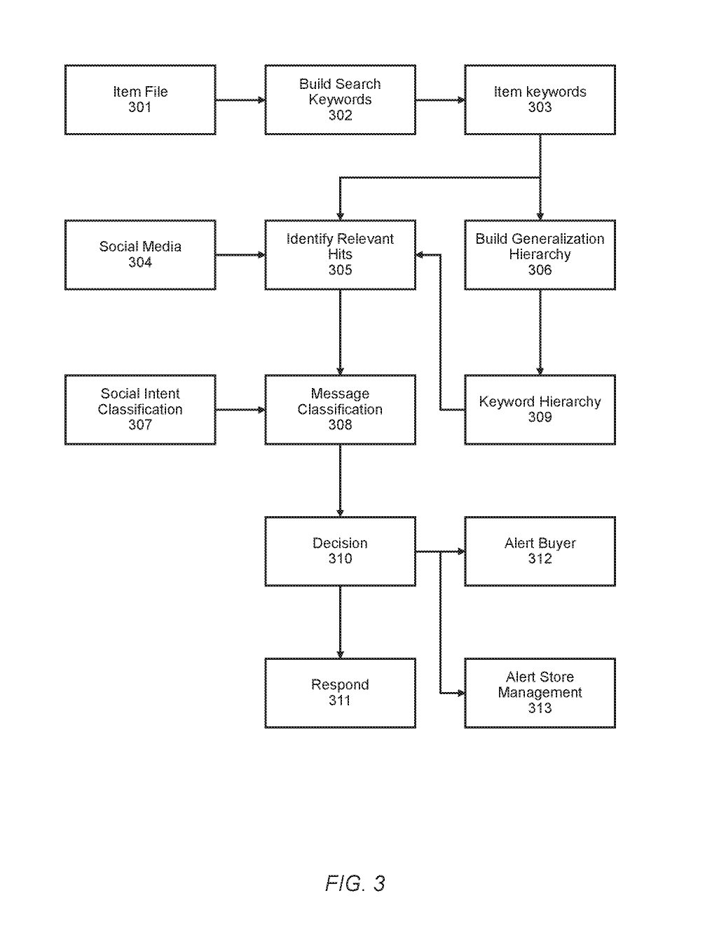

The control circuit 110 may comprise a central processing unit, a processor, a microprocessor, and the like and may be part of a server, a central computing system, a cloud server, and the like. The control circuit 110 may be configured to execute a set of computer readable instructions stored on a computer readable storage memory (not shown). The computer readable storage memory may comprise volatile and/or non-volatile memory and have stored upon it a set of computer readable instructions which, when executed by the control circuit 110, causes the system to analyze social media messages from social media services 190 using item identifier in the item identifier database 130. The system may further determine a task for a store location based on the aggregated messages and information in the inventory database 140. Generally, the computer readable instructions may cause the control circuit 110 to perform one or more steps in the methods and processes described with reference to FIGS. 2 and 3 herein.

The communication device 120 may comprise any communication interface configured to access the social media service 190 via a network (not shown). The communication device 120 may comprise one or more of a network adapter, a modem, a router, a data port, a wireless transceiver, and the like. Generally, the communication device 120 may comprise any device configured to allow the control circuit 110 to retrieve information from the social media service 190.

The social media service 190 may comprise one or more network accessible social media services with a plurality of users. In some embodiments, the social media service 190 may allow users to post public, private, restricted, broadcasted, and/or direct messages. In some embodiments, the social media includes user profiles associated authors of the messages. In some embodiments, a retail entity may have a social media profile and accesses the social media service through the company social media profile. In some embodiments, the social media service 190 may comprise one or more of Facebook, Twitter, Pinterest, Instagram, Google+, Tumblr, and the like. Generally, a social media service may be any network based user interface that allows people or companies to create, share, or exchange information, ideas, and pictures/videos in virtual communities and networks.

The item identifier database 130 may have stored in it, identifying texts for a plurality of items that may be offered for sale by a retail entity. Items that may be offered for sale by a retail entity may comprise one or more of items sold in one or more store locations of the retail entity, items a retail entity can order from one or more suppliers, items announced by one or more suppliers, and items having a Universal Product Code (UPC). In some embodiments, the identifiers may comprise identifying texts such as one or more of item name, item brand, item descriptor, item Universal Product Code (UPC), a link to an item page, and the like. In some embodiments, the identifiers may comprise keywords/key phrases descriptive of items (e.g. AAA battery, 2% milk, organic, etc.). In some embodiments, the item identifier database 130 may be built by parsing information associated with items that a retail entity may offer for sale. In some embodiments, the item identifiers may include commonly misspelled variants of item names, item brands, item descriptors, and keywords, etc. (e.g. “expresso” for “espresso”). In some embodiment, each identifier may be associated with one or more item categories (e.g. cereal), item types (e.g. corn flakes), and/or specific items (e.g. ACME frosted cornflakes). The information in the item identifier database 130 may be used by the control circuit 110 to match item descriptions in social media messages retrieved from the social media service 190 with one or more items, item types, and/or specific items to identify an item of interest for the message.

The inventory database 140 may have stored in it, inventory information of one or more store locations. In some embodiments, the inventory database 140 may further include online store inventory information. Inventory information may include information such as whether an item is offered for sale, not offered for sale, in-stock, out-of-stock, back ordered, low on stock, etc. The inventory information stored in the inventory database 140 may generally be obtained and/or updated through any conventional inventory tracking methods. In some embodiments, movement of items in and out of each store location may be recorded by associates and/or an inventory tracking system. In some embodiments, item sales, lost, shrink, and return information may also be used to determine the current count of items at each store location. Generally, the information in the inventory database 140 may be used by the control circuit 110 and/or another online store system to determine the inventory status of items at one or more locations.

In some embodiments, one or more of the item identifier database 130, the inventory database 140, and the memory device coupled to the control circuit 110 may be implemented on the same one or more memory devices or implemented on two or more separate devices. The item identifier database 130, the inventory database 140, and the memory device coupled to the control circuit 110 may comprise local, remote, networked, and/or cloud-based storage accessible by the control circuit 110. In some embodiments, one or more of the inventory database 140, the item identifier database 130, the control circuit 110, and the communication device 120 may be implemented on the same one or more physical devices or on two or more separate devices. For example, the control circuit 110, the communication device 120, and the item identifier database 130 may be implemented on a social media analysis server while the inventory database 140 may be a separately implemented database accessible by multiple systems.

Referring now to FIG. 2, a method of analyzing social media messages for inventory management is shown. In some embodiments, the steps shown in FIG. 2 may be performed by a processor-based device as such the control circuit 110 of FIG. 1 executing a set of computer readable instructions.

In step 201, the system aggregates social media messages from one or more social media services. In some embodiments, social media services may comprise the social media service 190 described with reference to FIG. 1 above. In some embodiments, a social media service may allow users to send/post public, private, restricted, broadcasted, and/or direct messages. In some embodiments, social media services may comprise one or more of Facebook, Twitter, Pinterest, Instagram, Google Plus, Tumblr, and the like. Generally, a social media service may be any network based user interface that allows people or companies to create, share, or exchange information, ideas, and pictures/videos in virtual communities and networks. In some embodiments, the system may aggregate all messages accessible to the retail entity such as public messages, semi-private message not restricted to the social media account of the retail entity, and messages directed at the social media account of the retail entity. In some embodiments, the system may aggregate only messages that reference the retail entity such as messages that mention or tag the retail entity or a service offered by the retail entity. In some embodiments, the system may also retrieve social media user profiles associated the aggregated messages.

In step 202, the system identifies messages of interest associated with customers seeking items to purchase among the aggregated messages. In some embodiments, the system may identify messages of interest by looking for keywords and/or phrases associated with customers seeking items to purchase. In some embodiments, the key phrases may include phrases such as “couldn't find . . . ,” “wish [retail entity] would sell . . . ,” “where can I buy . . . ,” etc. In some embodiments, the retail entity may designate a request message format and identify messages that follow the designated format as messages of interest. For example, the retail entity may ask customers (via a web page, in-store posters, etc.) to tag a phrase (e.g. #WantThis), direct the request to a specific social media account (e.g. @Walmart), and/or identify a store location (e.g. “Walmart store #3243”). In some embodiments, the system may only identify messages of interest that reference the retail entity and/or a retail entity identifier. In some embodiments, the system may identify all messages generally associated with customers seeking items to purchase whether the message references a specific company or not.

In step 203, for messages of interest identified in step 202, the system identifies an item of interest associated with each message. In some embodiments, the item of interest may be identified by comparing the content of the message with item identifiers in an item identifier database. In some embodiments, the identifiers may comprise one or more of item name, item brand, item descriptor, item Universal Product Code (UPC), and a link to an item page. In some embodiments, the identifiers may comprise keywords/key phrases descriptive of items (e.g. AAA battery, 2% milk, organic, etc.). In some embodiments, the item identifier database 130 may be built by parsing information associated with items that a retail entity may offer for sale. In some embodiments, item identifiers may include commonly misspelled variants of item name, item brand, item descriptor, and keyword, etc. (e.g. “expresso” for “espresso”). In some embodiments, each identifier may be associated with one or more of item category, item type, and a specific item. In some embodiments, an item may be identified based on a combination multiple keywords/phrases (e.g. “D Brand” and “cornflakes”). In some embodiments, the item identifier database may comprise the item identifier database 130 described with reference to FIG. 1 above.

In step 204, the system identifies a customer location for each identified message of interest. In some embodiments, the customer location may be identified based on one or more of a social media user profile, a geolocation tag of the message, a user entered location descriptor, and a user entered store location identifier. In some embodiments, the system may require that the customer identifies a store and/or geographic location in the item request social media message. In some embodiments, the system may derive customer location information from the geotag of the message and/or from the message author's social media profile.

In some embodiments, steps 203 and 204 may be repeated for each message of interest identified in 202, and steps 201-204 may be repeated periodically to build up a database of items of interest at a plurality of locations. While steps 202-206 are shown to be sequential in FIG. 2, in some embodiments, these steps may be performed in any order without departing from the spirit of the present disclosure. For example, the system may first identify messages describing items for sale and then determine whether the message is associated with a customer seeking an item. In some embodiments, one or more of steps 201-207 may be repeated periodically to analyze new messages posted onto social media service. In some embodiments, one or more of steps 201-204 may be performed utilizing the search and/or sort functions provided by the social media services. In some embodiments, one or more of steps 201-204 may include downloading social media message from social media servers for analysis. Generally, the system is configured track the number of requests for each item at one or more geographic locations with steps 201-205.

In step 205, the system determines an item in demand for a geographic location based on the aggregated items of interests and customer locations from a plurality of messages of interest. In some embodiments, the item in demand may be identified when a number of requests for an item for a geographic location exceed a predetermined threshold (e.g. 20, 50, etc.). The system may accumulate a tally of requests for each item at each geographic location over time. In some embodiments, the tally may be based on the number of messages and/or the number of unique requesters/users having the item of interest and customer location combination. In some embodiments, requests beyond a set age (e.g. 3 months old, 6 months old, etc.) may be removed and/or discounted from the tally. In some embodiments, an item in demand corresponds to an item that has been requested for a set number of times for a geographic location through social media. In some embodiments, the system may further be configured to detect a system-wide demand for items and determine whether to begin carrying an item and/or whether to increase inventory levels at one or more store locations.

In step 206, the system determines the stock information of the item in demand determined in step 205 at one or more store locations based on information in an inventory database. In some embodiments, the inventory database may comprise the inventory database 140 described with reference to FIG. 1 above. Inventory information may include information such as whether an item is offered for sale, not offered for sale, in-stock, out-of-stock, back ordered, etc. In some embodiments, the system may further determine stock information for similar and/or substitutable items (e.g. different brand, different packaging type, etc.). In some embodiments, the system may be configured to recommend an in-stock similar and/or substitutable item to the customer through social media messaging.

In step 207, the system determines whether the item in demand is stocked at the geographic location. A geographic location may comprise a single store location or a group of store locations in an area. If the item is not offered for sale in the geographic location, the system may automatically generate an order for the item in step 208. In some embodiments, the quantity of items ordered may be based on the number of messages of interest that identifies the item in demand in the geographic location and/or the amount of time it took for a predetermined threshold number of requests to be reached. The generated order may be submitted to a supplier via an ordering system and/or may be provided to store/company management for review. In some embodiments, once an order is placed, local store management may be instructed to prioritize the processing of the item in demand when the item arrives at the local store. In some embodiments, when the item in demand is received and placed on the sales floor of the local store, the system may further notify the customer in step 209. In some embodiment, the system may similarly generate an order for an item in demand if the item is offered for sale at the geographical location but is currently out of stock. In some embodiments, if there is a high demand for an item based on social media messages and the item is low in stock in a geographic region, the system may similarly generate an order for the item to increase the stock quantity of the item.

If, in step 207, the item is determined to be currently in-stock at the geographic location, in step 209 the system may notify the customer associated one or more of the messages of interests that identifies the item in demand. For example, the system may send a message such as “you can now buy X product at store A near you” to a customer via the social media service. If the item is back ordered, the system may notify the customer when the item is back in stock at the store and/or provide an estimated in-stock date. In some embodiments, instead of or in addition to generating an order for the item in demand, the system may suggest a substitute item to users associated with the messages of interest. In some embodiments, if the item is available for purchase through an online store, the system may recommend an online store purchase. In some embodiments, the retail entity may add the item in demand to its online store based on analyzing social media messages. In some embodiments, the system may automatically generate a response to messages of interest, the response may comprise one or more of an alternative store location for purchasing the item of interest, an alternative method for purchasing the item of interest, and an expected in-stock date for the item of interest.

Referring now to FIG. 3, a process diagram for analyzing social media messages for inventory management is shown. In some embodiments, an item file 301 may contain information on items that can be sold through a retail entity. Item file 301 may be analyzed to build search keywords 302 and the keywords may be stored as item keywords 303. The item keywords 303 may comprise words and phrases descriptive of an item category, an item type, and/or a specific item (e.g. AAA battery, milk, 2% milk etc.). In some embodiments, item keywords 303 may comprise one or more of a product name, a brand name, product description, etc. The item keywords 303 may be further analyzed to build a generalization hierarchy 306 of keywords and the hierarchy may be stored as keyword hierarchy 309. The keyword hierarchy 309 may organize keywords into categories and one or more levels of subcategories. For example, “2% milk,” “half gallon milk,” and “organic milk” may each be categorized under “milk.” In another example, “apple,” “orange,” and “grape” may be categorized under “fruit” and “Fuji” and “Granny Smith” may be categorized under the subcategory of “apple.” The categories may be used by the system to identify one or more items or item groups described in a social media message.

The system may aggregate messages from social media 304 and compare the content of the messages with the item keywords 303 and keyword hierarchy 309 to identify relevant hits 305. In some embodiments, relevant hits may comprise messages that mention products for sale (e.g. milk, organic milk, etc.). In some embodiments, the relevant hits may be further detected based on whether the messages are relevant to the retail entity (e.g. content mentions, tags, and/or is directed at the retail entity). In some embodiments, the messages may include directed social media messages and/or broadcasted social media messages. In some embodiments, the messages may comprise messages posted on a company social media page (e.g. “fan page”).

For messages identified as relevant, the system may perform message classification 308 using social intent classification 307 information. Social intent classification 307 may associate words and phrases (e.g. “I want,” ‘where to buy,” “not enough,” “looks old,” “too much,” etc.) with social intent (e.g. seeking new item, item out of stock, freshness issues, want a different size, want different variety, etc.). In some embodiments, the messages may be classified based on whether the content of the message is associated with a customer looking for a product to buy or a customer commenting on aspects of the product. In some embodiments, the social intent classification 307 is used by the system to analyze the meaning of social media message and sort the messages categories.

The system may then make a decision 310 and determine a response 311 to one or more relevant messages retrieved from social media 304. If based on message classification 308, many customers in an area are looking to buy a particular product and/or a variant of a product, the system may order the item for the area such that store(s) in the relevant area will begin to carry that product. In some embodiments, when a demand for a product currently being sold is detected, the system may increase the inventory level of the product as a response. In some embodiments, the system may determine one or more store locations at which the item is already offered for sale and/or is current in stock.

In some embodiments, the system may alert buyers 312 based the analysis. In some embodiments, if the item is already offered for sale at the geographic location, the system may respond to a social media message by notifying the customer associated with the message that the item is available at a location near them. The system generated response may identify a specific store location where the product may be purchased. In some embodiments, if the product is typically carried by a store but is currently out of stock, the system may communicate an expected back-in-stock date to the customer. In some embodiments, the system may generate an order for a new product to be offered at a store location and may notify the customer when the product becomes available at the store location.

In some embodiments, the system may alert store management 313 based on the analysis. For example, if an item is identified to be in high demand, store management may be instructed to feature the product in the store. In another example, if an item in high demand is newly offered at a store, store management may be instructed to prioritize the placing of the item on the sales floor when the item arrives.

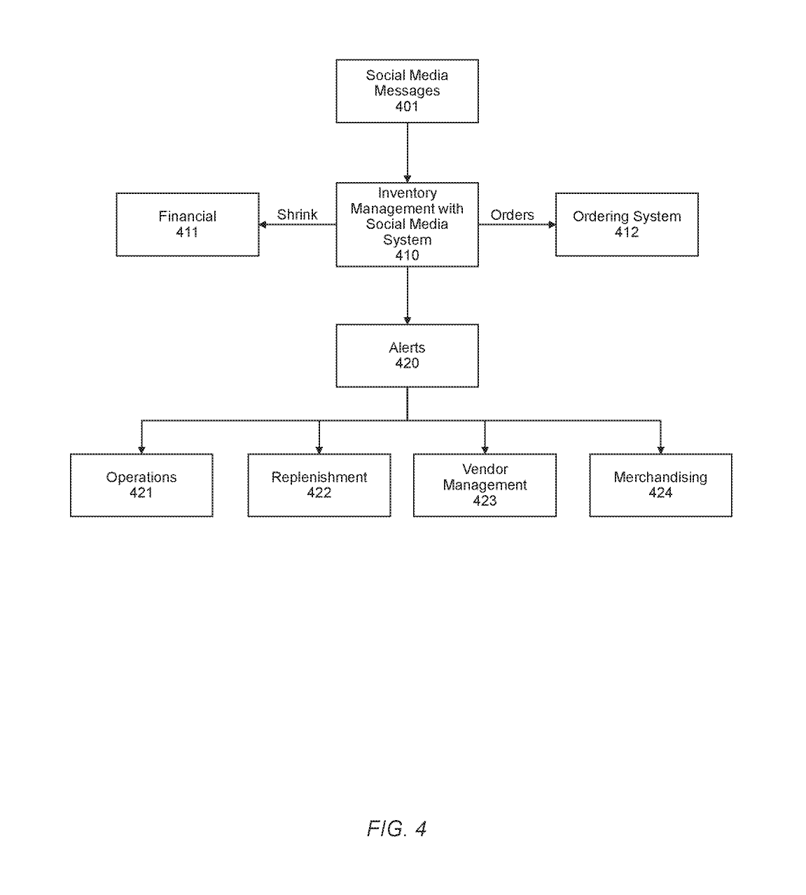

Referring now to FIG. 4, a system for analyzing social media messages for inventory management is shown. The system comprises an inventory management with social media system 410, an operations system 421, a replenishment system 422, a vendor management system 423, and a merchandising system 424.

The inventory management with social media system 410 aggregates social media messages 401 from the Internet. In some embodiments, the social media messages 401 may comprise public, private, restricted, broadcasted, and/or direct messages. In some embodiments, social media services may comprise one or more of Facebook, Twitter, Pinterest, Instagram, Google Plus, Tumblr, and the like. Generally, a social media service may be any network based user interface platform that allows people or companies to create, share, or exchange information, ideas, and pictures/videos in virtual communities and networks. In some embodiments, the system may aggregate all messages accessible to the retail entity such as public messages, semi-private message not restricted to the social media account of the retail entity, and messages directed at the social media account of the retail entity. In some embodiments, the system may aggregate only messages that reference the retail entity such as messages that mention or tag the retail entity or a service offered by the retail entity. In some embodiments, the system may also retrieve social media user profiles associated with the aggregated messages.

The system 410 may perform keyword analysis and/or natural language analysis to determine whether the message should generate an order and/or an alert. In some embodiments, the system 410 may use machine learning to categorize messages. For example, a database of messages previously categorized by workers may be analyzed by the system to associate keywords, key phrases, symbols, sentence structures, syntax, etc. with different categories of messages. The system may then applied the rules learned from analyzing human sorted messages to other social media messages. In some embodiments, the machine learning algorithm may comprise pattern recognition and predictive analytics algorithms employed in artificial intelligence computing. In some embodiments, social media messages may be analyzed using natural language processing (NLP) algorithm and/or an automated reasoning algorithm such as the algorithms utilized by IBM's Watson, Amazon's Alexa, Apple's Siri, or other similar systems. In some embodiments, the system 410 may comprise one or more NLP programs, including open source and/or commercially available products such as Stanford's Core NLP Suite, SpaCy by MIT, Natural Language Toolkit for Python, Apache Lucene and Solr, Apache OpenNLP, Salience and Semantria API by Lexalytics, and similar products. An example of an NLP software toolkit is described in Manning, Christopher D., et al. “The Stanford CoreNLP natural language processing toolkit.” ACL (System Demonstrations). 2014, incorporated herein by reference in its entirety.

In some embodiments, if the system receives an “out of stock” type message (e.g. “store 123 is out of organic milk,” “can't find any pita chips here”), the system may generate an order for the item via the ordering system 412. In some embodiments, the system may compare the inventory information with the reported stock level to determine whether there is shrinkage (e.g. damage, lost, thief) associated with the item. For example, if the inventory system indicates that there are 10 unsold units of X-type baby food but customer social media messages report that no X-type baby food can be found in the store, the system may determine that there is a 10 unit shrinkage of X-type baby food. In some embodiments, the shrinkage may be confirmed through a threshold number (e.g. 2, 3, etc.) of “out of stock” messages. The shrinkage information detected based on social media messages may be reported to a financial system 411 for accounting.

In some embodiments, the aggregated social media messages may be used to generate alerts 420 for one or more of an operations system 421, a replenishment system 422, a vendor management system 423, and a merchandising system 424. In some embodiments, the operations system 421 refers to a system that manages the stocking and maintenance of a store location. In some embodiments, the replenishment system 422 refers to a system that manages the periodic reordering of products from distribution centers and/or vendors. In some embodiments, the vendor management system 423 refers to a system that manages communications and supply chain with vendors. In some embodiments, the merchandising system 424 refers to a system that determines and manages the products and quantities of products carried at one or more stores. In some embodiments, the alert type, the alert content, and/or the alert recipient(s) may be determined based on the category of the social media message determined by the system 410. For example, if an out-of-stock condition is detected through social media messages, the system may notify the replenishment system 422 and the operations system 421 to restock the shelves. In some embodiments, if a trend of increasing demand is detected, the system may notify the merchandising system 424 to adjust the product quantity for one or more store locations and notify the operations system 421 to adjust the shelf space allotted to the product. In some embodiments, the system 410 may also notify a vendor through the vendor management system 423 so the vendor may increase production and/or prepare additional units of the product.

In some embodiments, one or more of the social media system 410, the operations system 421, the replenishment system 422, the vendor management system 423, and the merchandising system 424 may be associated with a store or a plurality of store locations. In some embodiments, one or more of the social media system 410, the operations system 421, the replenishment system 422, the vendor management system 423, and the merchandising system 424 may be implemented on separate hardware systems or shared one or more hardware systems. In some embodiments, one or more of the social media system 410, the operations system 421, the replenishment system 422, the vendor management system 423, and the merchandising system 424 may communicate with each other via a wired and/or wireless network such as a private network, a virtual private network, a secure network, a local network, and the Internet.

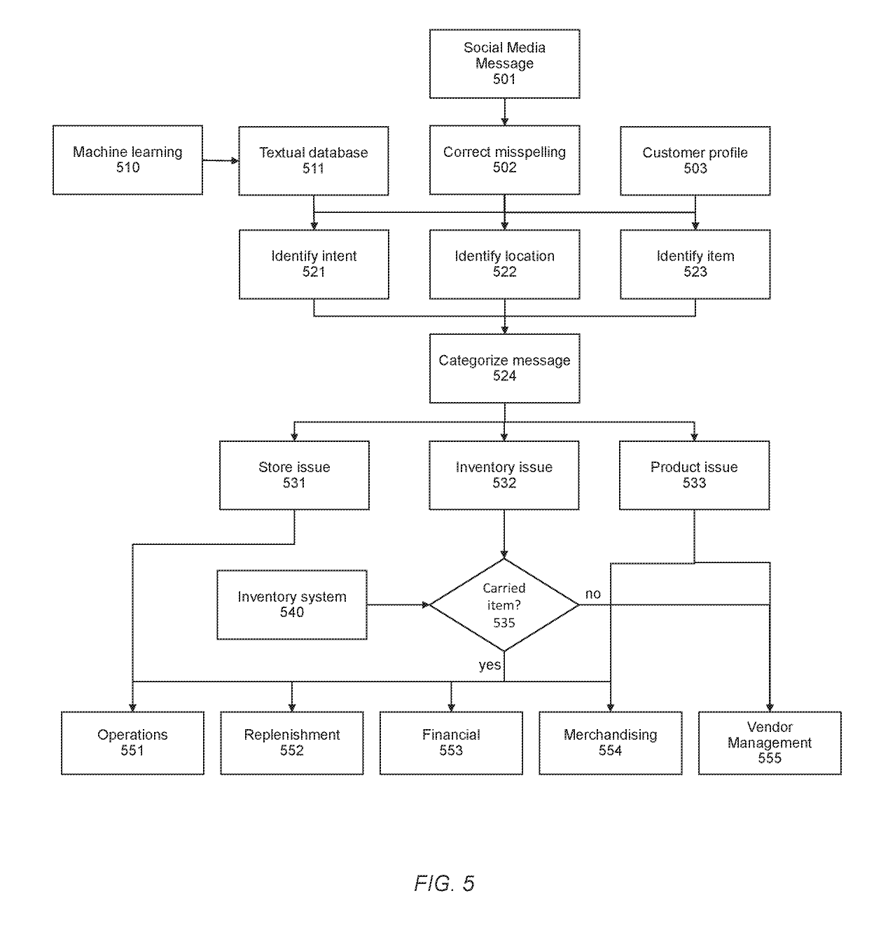

Referring now to FIG. 5, a process for analyzing social media messages for inventory management is shown. In some embodiments, one or more steps shown in FIG. 5 may be performed by a processor-based device as such the control circuit 110 of FIG. 1 executing a set of computer readable instructions, or similar devices.

In step 501, social media messages are aggregated. In some embodiments, the social media messages may comprise public, private, restricted, broadcasted, and/or direct messages. In some embodiments, social media services may comprise one or more of Facebook, Twitter, Pinterest, Instagram, Google Plus, Tumblr, and the like. Generally, a social media service may be any network based user interface that allows people or companies to create, share, or exchange information, ideas, and pictures/videos in virtual communities and networks. In some embodiments, the system may aggregate all messages accessible to the retail entity such as public messages, semi-private message not restricted to the social media account of the retail entity, and messages directed at the social media account of the retail entity. In some embodiments, the system may aggregate only messages that reference the retail entity such as messages that mention or tag the retail entity or a service offered by the retail entity. In some embodiments, the system may also retrieve social media user profiles associated the aggregated messages. In step 502, the system corrects any misspelling in the social media messages. In some embodiments, the system may further convert abbreviations and/or acronyms into full words. In some embodiments, the correction of misspellings, abbreviations, and acronyms may be performed by an autocorrect software (e.g. Microsoft AutoCorrect) and/or based on a database of commonly misspelled and abbreviated words.

The social media message may then go through textual analysis and/or natural language analysis to identify the intents of the message in step 521, identify a location in step 522, and identify the item in step 523. In some embodiments, the intent of a message may comprise the meaning of the message such as a desire for the product, an interest in the product, a disinterest of the product, a comment on a store inventory, a comment on purchased product, a recommendation of a product, a question about the product, a comment on the state of the store, etc. In some embodiments, the location may correspond to a store location and/or geographic location. In some embodiments, the identified item may correspond to an item category, item type, and/or a specific product. In some embodiments, steps 522 and 523 may correspond to steps 204 and 203 described with reference to FIG.2 herein. In some embodiments, step 521 may comprise or be used to perform step 202 described with reference to FIG. 2 herein.

In some embodiments, the system may comprise a textual database 511 storing associations between words, phrases, symbols, and syntaxes associated with different types of intent, location, and/or item. In some embodiments, the textual database 511 may be built and/or updated via machine learning in step 510. For example, a database of messages categorized by employees may be analyzed by the system to associate keywords, key phrases, symbols, sentence structures, syntax, etc. with different intents, locations, and items. The associations may then be used to identify intends, locations, and/or items associated with future messages. In some embodiments, the machine learning algorithm may comprise pattern recognition and predictive analytics algorithms employed in artificial intelligence computing. In some embodiments, the social media messages may be analyzed using a natural language processing (NLP) algorithm and/or an automated reasoning algorithm such as the algorithms utilized by IBM's Watson, Amazon's Alexa, Apple's Siri, or other similar systems. In some embodiments, the system may comprise one or more NLP programs, including open source and/or commercially available products such as Stanford's Core NLP Suite, SpaCy by MIT, Natural Language Toolkit for Python, Apache Lucene and Solr, Apache OpenNLP, Salience and Semantria API by Lexalytics, and similar products. In some embodiments, one or more of steps 521, 522, and 523 may further be performed based on a customer profile 503 of the customer associated with the social media account. In some embodiments, the message location may be identified based on locations associated the customer. In some embodiments, if the message references a product type (e.g. milk), the customer's purchase history in the customer profile 503 may be used to narrow down the specific product referred to in the message (e.g. X-brand 1% organic milk). In some embodiments, the customer's intent may be determined, at least partially based on the customer's message history in the customer's profile. For example, if the customer had used a phrase to indicate a desire for an item in the past, the system may determine that the new message has the same intent based on the past categorization of similar messages. In some embodiments, the system may analyze the customer's profile local and/or message history to assign the customer to a linguistic group (e.g. Southern, young, New York, etc.) and use the linguistic group to determine the customer's intent and/or their described item. For example, “coke” may be understood as a generic term for soft drinks for a customer in the Southwest linguistic group but understood as a cola type soft drink for a customer from California.

In step 524, the system categorizes the messages based on the message's intent, location, and identified item. In some embodiments, the categorization of the message may be based on machine learning where previously categorized messages are analyzed by a computer for categorization patterns. In some embodiments, the messages may be determined to correspond to a store issue 531, an inventory issue 532, and/or a product issue 533. The issues may then be reported to one or more of an operations system 551, a replenishment system 552, a financial system 553, a merchandising system 554, and a vendor management system 555. In some embodiments, the operations system 551 refers to a system that manages the stocking and maintenance of a store location. In some embodiments, the replenishment system 552 refers to a system that manages the periodic reordering of products from distribution centers and/or vendors. In some embodiments, the vendor management system 555 refers to a system that manages communications and supply chain with vendors. In some embodiments, the merchandising system 554 refers to a system that determines and manages the products and quantities of products carried at one or more stores. In some embodiments, the financial system 553 refers to the accounting and ledgers system of a store.

A store issue 531 may refer to a message that identifies an issue with the state of a particular store. For example, the message may indicate that the store is messy, has no available shopping carts, has no parking spaces, etc. Store issue type messages may be sent to an operations system 551 for consideration and redress. In some embodiments, store issues may further be categorized into immediate issues and long term issues. For example, the system may notify store operations that an aisle needs cleanup or a bathroom needs attention, but may aggregate long term issues such as parking space shortage and shopping cart conditions into a report for long term planning.

An inventory issue 532 may refer to a message that identifies an item that a customer cannot find in a store. The system may determine whether the item is carried by the store in step 535 based on inventory information stored in the inventory system 540. If the item is carried by the store, the system may compare the expected inventory to the inventory condition reported through social media messages to determine whether the out of stock condition is due to shrinkage (e.g. damage, theft, loss) and/or an underestimated demand of the product. In some embodiments, if the out of stock condition is due to shrinkage, the system may report the shrinkage to the financial system 553, the operations system 551, and the replenishment system 552. Shrinkage may be detected based on comparing the expected inventory of the product with reporting of out of stock conditions from social media messages. If the out of stock condition is due to an underestimation of demand, the system may notify the merchandising system 554 to adjust the stock quantity of the item for further orders and notify the replenishment system 552 to reorder the item. In some embodiments, demand for a product may be determined based on how fast the product sells through. An underestimation of the demand may be detected based on the product being sold out before scheduled replenishment. In some embodiments, if a significant demand increase is detected based on social media messages, the system may further notify vendors via the vendor management system 555. If the item is not carried by the store, the system may notify the merchandising system 554 and the merchandising system 554 may determine whether to begin stocking the item at the store location. In some embodiments, if a significant demand increase is detected based on social media messages, the system may further notify vendors via the vendor management system 555 to increase production. In some embodiments, the system may further response to the social media message if the product mentioned in the social media message is restocked and/or newly offered at a store location.

A product issue 533 may refer to a message that discusses a product. In some embodiments, a product issue may comprise a product complaint, product review, product customer service request, etc. In some embodiments, the system may forward a product issue 533 to the operations system 551 or to a vendor via the vendor management system 555. For example, issues with the freshness of produce may be forwarded to the operations system 551 of the store, while issues with electronic product malfunctions may be forwarded to the vendor. In some embodiments, product issues 533 may also be provided to the merchandising system 554 to determine whether to continue to stock the product.

The routing of messages and issues in FIG. 5 are provided as an example only. In some embodiments, the system may comprise a plurality of rules for any number of categories of messages. In some embodiments, one or more of the operations system 551, the replenishment system 552, the financial system 553, the merchandising system 554, and the vendor management system 555 may be configured to automatically take action based on the received messages. For example, the replenishment system 552 may be configured to automatically place an order for an item based on social media messages. In some embodiments, the system may be configured to translate the messages into data and/or actionable tasks based on one or more of steps 521, 522, 523, and 524. For example, the one or more of the identified intent, the identified location, and the identified item may be provided to the system. In another example, “I can't find brand C cereal” and “there is no more brand C cereal” may both be provided to the replenishment system 552 as “reorder UPC #12345 for store #567.” In some embodiments, one or more of the operations system 551, the replenishment system 552, the financial system 553, the merchandising system 554, and the vendor management system 555 may aggregate a plurality of messages before triggering an automatic action. For example, the merchandising system 554 may aggregate messages over several days to estimate the future demand for a product prior to adjusting the stock quantity of the product. In some embodiments, one or more of the operations system 551, the replenishment system 552, the financial system 553, the merchandising system 554, and the vendor management system 555 may aggregate the messages into a report for managers and workers.

One of more steps in FIG. 5 may be repeated for each message aggregated by the system. As an example, the system may process “@walmart lexingtn store all out of gren peas” as follows. In step 501, the system may first perform autocorrect and convert the message to “@walmart Lexington store all out of green peas.” The system may then parse the message into three portions based on NLP and/or syntax analysis. The first portion “Lexington” may be tagged as a location identifier in step 522. The system may further use the metadata of the message and/or the customer profile 503 to determine whether the customer is referring to Lexington in Ky., Massachusetts, or Oregon, etc. The second portion “all out of” may be tagged as an intent identifier in step 521. The system may then match the phrase “all out of” with the intent of expressing “item out of stock” based on the textual database 511 and/or through an NLP software. The third portion “green peas” may be tagged as an item identifier in step 523. The system may then search a product database to match “green peas” with product descriptors in the product database to identify the item referenced in the message. In some embodiments, if more than one item types are identified (e.g. frozen peas, canned peas, fresh peas), the system may select an item type based on the customer's purchase history and/or demographic information. For example, if the customer had made repeated purchases of frozen peas before, the system may determine that the customer is referring to frozen peas. In another example, if the customer mostly purchases from the fresh produce department, the system may determine that the customer is referring to fresh peas.

In step 524, the system may categorize the message as an inventory issue because the identified intent in step 521 is that of “item out of stock” and the message identifies a product. In step 535, the system then checks the inventory system 540 of the store location identified in step 522 (e.g. Lexington, Ky. store #1234) for the item identified in step 523 (e.g. frozen peas). If the Lexington, Ky. store does not currently carry frozen peas, the system may notify the merchandising system 554 that there is one unmet demand for frozen peas at the Lexington, Ky. store. The merchandising system 554 may then aggregate the unmet demands over time and determine whether to start carrying frozen peas at the Lexington, Ky. store. If in step 535, the inventory system 540 shows that the Lexington, Ky. store currently carries frozen peas and there is sufficient stock, the system may instruct the operations system 551 to bring frozen peas from the storage area to the sales floor or notify store management to check for shrinkage. If, in step 535, the inventory system 540 shows that the Lexington, Ky. store carries frozen peas but is currently out of stock, the system may notify the replenishment system 552 to place a new order for frozen peas and/or notify the merchandising system 544 to adjust the estimated demand for frozen peas for future vendor orders.

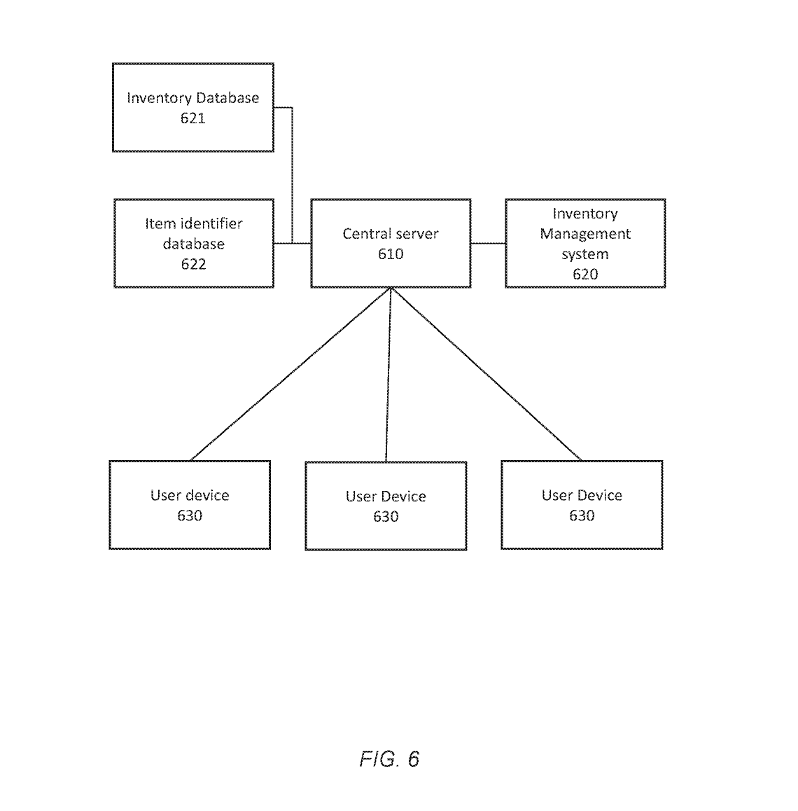

Referring now to FIG. 6, a system for analyzing social media messages for inventory management is shown. The system comprises a central server 610, an inventory database 621, an item identifier database 622, a plurality of user devices 630, and an inventory management system 620.

The user devices 630 may comprise personal devices such as one or more of a smartphone, a portable device, a personal computer, a tablet computer, a wearable device, a personal assistance device, and the like. A user device 630 may generally comprise a processor, a memory, and one or more user input/out devices (e.g. touch screen, microphone, speaker, buttons, etc.). In some embodiments, the user devices 630 may be configured to perform one or more of the steps 202, 203, and 204 described with reference to FIG. 2, steps 305, 308, 307, and 310 described with reference to FIG. 3, and steps 521, 522, 523, and 524 described with reference to FIG. 5. In some embodiments, the user device 630 may comprise a software program (e.g. mobile app, desktop program, etc.) configured to analyze social media messages for one or more of message intent, customer location, and referenced product. In some embodiments, the software program may comprise natural language processing (NLP) algorithm and/or an automated reasoning algorithm such as the algorithms utilized by IBM's Watson, Amazon's Alexa, Apple's Siri, or other similar systems. In some embodiments, the user device 630 may comprise one or more NLP programs, including open source and/or commercially available products such as Stanford's Core NLP Suite, SpaCy by MIT, Natural Language Toolkit for Python, Apache Lucene and Solr, Apache OpenNLP, Salience and Semantria API by Lexalytics, and similar products. In some embodiments, the message may be analyzed, at least in part, by the built-in NPL and/or question answering software of the device (e.g. Apple's Siri, Amazon's Alexa, etc.)

In some embodiments, when a customer posts or sends a social media message, the software program may analyze the message based on one or more steps described with reference to FIGS. 2, 3, and 5 and upload the analyzed data to the central server 610. In some embodiments, the software program may be configured to utilized processing power of the user device 630 when the device is idled. For example, the software program may perform NLP on the messages aggregated during the day time at night time (e.g. 1 am-5 am). In some embodiments, the software program may be configured to process the messages only while the user device 630 is plugged in and the device screen is turned off

In some embodiments, a user device 630 may access one or more databases such as the inventory database 621, the item identifier database 622, a textual database, a customer profile database, etc. to analyze social media messages based on one or more steps described with reference to FIGS. 2, 3, and 5. In some embodiments, at least a portion of the databases may be stored locally at the user device 630, directly accessed by the user device 630 through a network (e.g. Internet), and/or accessed via the central server 610. In some embodiments, a user device 630 may be configured to provide the identified intent, location, and/or product identity to the central server 610 instead of or in addition to the original social media message. The central server 610 may then use the identified intent, location, and/or product identity to provide instructions to the inventory management system 620 instead of performing further social media message analysis. In some embodiments, the communications between the central server 610 and the inventory management system 620 may be similar to those described with reference to FIGS. 2-5 herein. In some embodiments, the user device 630 and the central server 610 may share the task of processing social media messages. For example, the user device 630 may identify the intent associated with the message using NLP while the central server 610 may identify the referenced product using the item identifier database 622. In some embodiments, the user devices 630 may be configured to select messages of interest based on analyzing the messages and only relay messages determined to of interest to the central server 610. The central server 610 may then analyzed the identified messages of interest for locations and referenced products.

In some embodiments, a user device 630 may be configured to analyze messages sent via the user device 630 and/or associated with the social media account of the owner of the user device 630. In some embodiments, the user devices 630 may be configured to analyze social media messages aggregated from other sources. In some embodiments, the central server 610 may be configured to assign aggregated social media messages to different user devices 630 to analyze. In some embodiments, the social media messages may be assigned based on the current and/or predicted processor activity associated with one or more user devices 630. With the system shown in FIG. 6, the analysis of social media messages may be performed using spare processing capabilities of user devices 630, and the processing load for analyzing social media messages may be distributed among a plurality of user devices 630.

With the methods, systems, and apparatuses described herein, retail stores may analyze social media messages to identify items that customers wish to purchase. The demand may be determined separately for different geographic regions. The demand information may then be used to determine the selection of items and/or quantities of items to stock at store locations.

In one embodiment, a system for analyzing social media messages comprises: a communication device configured to communicate with one or more social media services, an item identifier database configured to store a plurality of item identifiers each associated with an item for sale and one or more identifying texts associated with each item identifier, an inventory database configured to store inventory information for a plurality of store locations, and a control circuit coupled to the communication device, the item identifier database, and the inventory database, wherein the control circuit is configured to: aggregate a plurality of social media messages from the one or more social media services via the communication device, identify a intent associated with each of the plurality of social media messages based on textual analysis, identify, within the plurality of social media messages, a plurality of messages of interest associated with customers seeking items to purchase based on the intent associated with each of the plurality of social media messages, for each message of interest of the plurality of messages of interest: identify an item of interest based on comparing a text of the message of interest with identifying texts in the item identifier database, and identify a customer location associated with the message of interest, determine an item in demand for a geographic location based on items of interests and customer locations identified in the plurality of messages of interest, determine a stock information of the item in demand in the geographic location based on the inventory database; and in the event that the item in demand is not stocked at the geographic location, automatically generate an order for the item in demand to be stocked at the geographic location.

In one embodiment, a method for analyzing social media messages comprises: aggregating a plurality of social media messages from one or more social media services via a communication device, identifying a intent associated with each of the plurality of social media messages based on textual analysis, identifying, with a control circuit and within the plurality of social media messages, a plurality of messages of interest associated with customers seeking items to purchase based on the intent associated with each of the plurality of social media messages, for each message of interest of the plurality of messages of interest: identifying an item of interest based on comparing a text of the message of interest with identifying texts in the item identifier database storing a plurality item identifiers each associated an item for sale and one or more identifying texts associated with each item identifier, and identifying a customer location associated with the message of interest, determining, with the control circuit, an item in demand for a geographic location based on items of interests and customer locations associated with the plurality of messages of interest, determining, with the control circuit, a stock information associated with the item in demand in the geographic location based on an inventory database storing inventory information for a plurality of store locations, and in the event that the item in demand is not stocked at the geographic location, automatically generating an order for the item in demand to be stocked at the geographic location.

In one embodiment, an apparatus for analyzing social media messages comprises: a non-transitory storage medium storing a set of computer-readable instructions, and a control circuit configured to execute the set of computer readable instructions which causes to the control circuit to: aggregate a plurality of social media messages from one or more social media services via a communication device, identify a intent associated with each of the plurality of social media messages based on textual analysis, identify, with a control circuit and within the plurality of social media messages, a plurality of messages of interest associated with customers seeking items to purchase based on the intent associated with each of the plurality of social media messages, for each message of interest of the plurality of messages of interest: identify an item of interest based on comparing a text of the message of interest with identifying texts in the item identifier database storing a plurality item identifiers each associated an item for sale and one or more identifying texts associated with each item identifier, and identify a customer location associated with the message of interest, determine, with the control circuit, an item in demand for a geographic location based on items of interests and customer locations associated with the plurality of messages of interest, determine, with the control circuit, a stock information associated with the item in demand in the geographic location based on an inventory database storing inventory information for a plurality of store locations, and in the event that the item in demand is not stocked at the geographic location, automatically generating an order for the item in demand to be stocked at the geographic location.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for analyzing social media messages for inventory management at retail product sales facilities, the system comprising:
a communication device configured to communicate with one or more social media services;
an item identifier database configured to store a plurality of item identifiers each associated with an item for sale and one or more identifying texts associated with each item identifier;
an inventory database configured to store inventory information for a plurality of store locations; and
a control circuit coupled to the communication device, the item identifier database, and the inventory database, wherein the control circuit is configured to:
aggregate a plurality of social media messages from the one or more social media services via the communication device;
identify a intent associated with each of the plurality of social media messages based on textual analysis;
identify, within the plurality of social media messages, a plurality of messages of interest associated with customers seeking items to purchase based on the intent associated with each of the plurality of social media messages;
for each message of interest of the plurality of messages of interest:
identify an item of interest based on comparing a text of the message of interest with identifying texts in the item identifier database; and
identify a customer location associated with the message of interest;
determine an item in demand for a geographic location based on items of interests and customer locations identified in the plurality of messages of interest;
determine a stock information of the item in demand in the geographic location based on the inventory database; and
in the event that the item in demand is not stocked at the geographic location, automatically generate an order for the item in demand to be stocked at the geographic location.

2. The system of claim 1, wherein the plurality of messages of interest are identified based on one or more of a keyword and a key phrase associated with customers seeking items to purchase.

3. The system of claim 1, wherein the plurality of messages of interest are identified based on a retail entity identifier.

4. The system of claim 1, wherein the plurality of messages of interest comprises one or more of: directed social media messages and broadcasted social media messages.

5. The system of claim 1, wherein the identifying texts associated with each item identifier comprises one or more of: item name, item brand, item descriptor, item Universal Product Code (UPC), and a link to an item page.

6. The system of claim 1, wherein the customer location is identified based on one or more of a social media user profile, a geolocation tag, a user entered location descriptor, and a user entered store location identifier.

7. The system of claim 1, wherein the item in demand for the geographic location is determined based on whether a number of messages of interest associated with the geographic location that mentions the item exceed a predetermined threshold.

8. The system of claim 1, wherein the control circuit is further configured to automatically generate a response to messages of interest, the response comprises one or more of: an alternative store location for purchasing the item of interest, an alternative method for purchasing the item of interest, and an expected in-stock date for the item of interest.

9. The system of claim 1, wherein the control circuit is further configured to:
determine that the item in demand has been stocked in the geographic location; and
automatically generate a notification to users associated with messages of interest mentioning the item in demand.

10. The system of claim 1, wherein the geographic location comprises a plurality of stores.

11. The system of claim 1, wherein textual analysis comprises performing natural languag processing (NLP) on the plurality of social media messages to determine the intent associated with each of the plurality of social media messages.

12. A method for analyzing social media messages for inventory management at retail product sales facilities, the method comprising:
aggregating a plurality of social media messages from one or more social media services via a communication device;
identifying, with a control circuit, an intent associated with each of the plurality of social media messages based on textual analysis;
identifying, with the control circuit and within the plurality of social media messages, a plurality of messages of interest associated with customers seeking items to purchase based on the intent associated with each of the plurality of social media messages;
for each message of interest of the plurality of messages of interest:
identifying an item of interest based on comparing a text of the message of interest with identifying texts in an item identifier database storing a plurality item identifiers each associated an item for sale and one or more identifying texts associated with each item identifier; and
identifying a customer location associated with the message of interest;
determining, with the control circuit, an item in demand for a geographic location based on items of interests and customer locations associated with the plurality of messages of interest;
determining, with the control circuit, a stock information associated with the item in demand in the geographic location based on an inventory database storing inventory information for a plurality of store locations; and
in the event that the item in demand is not stocked at the geographic location, automatically generating an order for the item in demand to be stocked at the geographic location.

13. The method of claim 12, wherein the plurality of messages of interest are identified based on one or more of a keyword and key phrase associated with customers seeking items to purchase.

14. The method of claim 12, wherein the plurality of messages of interest are identified based on a retail entity identifier.

15. The method of claim 12, wherein the plurality of messages of interest comprises one or more of: directed social media messages and broadcasted social media messages.

16. The method of claim 12, wherein the identifying texts associated with each item identifier comprises one or more of: item name, item brand, item descriptor, item Universal Product Code (UPC), and a link to an item page.

17. The method of claim 12, wherein the customer location is identified based on one or more of a social media user profile, a geolocation tag, a user entered location descriptor, and a user entered store location identifier.

18. The method of claim 12, wherein the item in demand for the geographic location is determined based on whether a number of messages of interest associated with the geographic location that mentions the item exceed a predetermined threshold.

19. The method of claim 12, further comprising: automatically generating, with the control circuit, a response to the message of interest, the response comprises one or more of: an alternative store location for purchasing the item of interest, an alternative method for purchasing the item of interest, and an expected in-stock date for the item of interest.

20. The method of claim 12, further comprising:
determining that the item in demand has been stocked in the geographic location; and
automatically generating a notification to users associated with messages of interest mentioning the item in demand.

21. The method of claim 12, wherein textual analysis comprises performing natural languag processing (NLP) on the plurality of social media messages to determine the intent associated with each of the plurality of social media messages.

22. An apparatus for analyzing social media messages for inventory management at retail product sales facilities, the apparatus comprising:
a non-transitory storage medium storing a set of computer readable instructions; and
a control circuit configured to execute the set of computer readable instructions which causes to the control circuit to:
aggregate a plurality of social media messages from one or more social media services via a communication device;
identify an intent associated with each of the plurality of social media messages based on textual analysis;
identify, with the control circuit and within the plurality of social media messages, a plurality of messages of interest associated with customers seeking items to purchase based on the intent associated with each of the plurality of social media messages;
for each message of interest of the plurality of messages of interest:
identify an item of interest based on comparing a text of the message of interest with identifying texts in an item identifier database storing a plurality item identifiers each associated an item for sale and one or more identifying texts associated with each item identifier; and
identify a customer location associated with the message of interest;
determine, with the control circuit, an item in demand for a geographic location based on items of interests and customer locations associated with the plurality of messages of interest;
determine, with the control circuit, a stock information associated with the item in demand in the geographic location based on an inventory database storing inventory information for a plurality of store locations; and
in the event that the item in demand is not stocked at the geographic location, automatically generating an order for the item in demand to be stocked at the geographic location.
